(19) United States
(12) Patent Application Publication
(10) Pub. No.: US 2013/0067215 A1
(43) Pub. Date: Mar. 14, 2013

(54) System for Enabling a Virtual Private Network ("VPN") Over an Unsecured Network

(71) Applicant: Michael R. Derby, Madison, AL (US)

(72) Inventor: Michael R. Derby, Madison, AL (US)

(73) Assignee: AvaLAN Wireless Systems, Inc.

(21) Appl. No.: 13/608,647

(22) Filed: Sep. 10, 2012

Related U.S. Application Data
(60) Provisional application No. 61/532,194, filed on Sep. 8, 2011.

(51) Int. Cl. H04L 9/00

(52) U.S. Cl. 713/153

(57) ABSTRACT

A system for enabling a virtual private network over an unsecured network includes a local network coupled to an internet server configured with a firewall. Coupled to both is an appliance that includes a cryptographic module. A remote modem, for example, a cellular modem, is coupled to a counterpart appliance that includes a compatible cryptographic module. The two modules are keyed to be exclusively, mutually responsive to each other and enable the transmission of encrypted data between the local network and the remote modem. The appliance coupled to the remote modem may further be coupled to either of a remote computer device or a remote network.

### CROSS-REFERENCE TO RELATED APPLICATIONS

This application claims priority to U.S. Provisional Application No. 61/532,194 filed Sep. 8, 2011, and incorporated herein by reference.

### BACKGROUND

1. Field

The present application is directed to a system that relates generally to network communications, and, in particular to wireless network communications, and in particular to wireless communications over an unsecured cellular network.

2. Description of the Problem and Related Art

Connection of conventional network communication devices with a cellular modem can be challenging. In most cases, such devices are operating backwards from how typical users utilize an Internet connection over a cellular modem. Users typically get data from the Internet while the devices only provide information to network administrators that have knowledge of the internet address of the device.

To protect devices on a local area network (“LAN”) from unsolicited Internet probes, a firewall is used to restrict access from external users trying to gain access to LAN devices. A conventional firewall does not restrict outbound requests to the Internet while incoming requests from the Internet are subjected to heightened scrutiny, or forbidden. The only way to pass through a firewall from the Internet is to be invited by an internal user. The firewall registers and tracks each local user's outbound requests with corresponding responses from the Internet. These matching responses from the Internet are approved by the firewall and forwarded onto the LAN user, whereas data coming from the Internet that doesn't have a registered request is rejected, and such data does not enter the LAN.

A firewall's registration process uses “port numbers” to keep track of the flow of incoming and outgoing data requests and responses. A port is registered and opened to a specific Internet address when an outbound request is made and the response comes back to the same port for validation by the firewall. Only responses from the queried Internet address are allowed through the firewall. It is possible to manually set up ports on a firewall to “forward” incoming data requests from the Internet. The firewall is programmed by its administrator to open specific ports and will then directly forward all data that is received on that port to a specific internal network address. However, port forwarding can compromise local network security because it opens a hole in the firewall for unauthorized probing and network entry. Now, in addition to the firewall, protection of the LAN must be performed in part by the local device receiving the forwarded data. Devices receiving data from a forwarded port on the firewall must have well-designed security features because they will be directly visible to outside Internet users with possibly nefarious intentions. Many legacy network devices do not have adequate security provisions because they were designed for use only by known users on safe internal networks.

Port forwarding works with traditional Internet service providers (“ISP”) because ISPs do not restrict incoming ports from the Internet and leave management of firewall protection to the LAN owner. However, this is not the case with cellular network ISPs. These providers typically use a filter that blocks the incoming requests that would not normally be handled by the user's firewall. This filter does not impact users who send outbound (HTTP/web) requests to the Internet, but it does block inbound requests that are both maliciously-motivated (i.e., from hackers, or thieves) and, unfortunately, from well-intended users desiring to connect a remote devices with a LAN.

Conventionally, the cellular network provider's filter needs to be off to connect a remote device to a LAN over a public cellular network, which brings a challenge and a risk. The former is finding and convincing the cellular network administrator to disable cellular carrier's filter. The latter is in turning off the carrier's filter allows unsolicited probes through the cellular network to the LAN consume the user's usage allowance from the cellular carrier.

Then, upon clearing the hurdle of establishing un-filtered wireless access to correctly forward ports, the next challenge is to get a fixed Internet address. Cellular connections are typically pre-configured with a non-fixed, i.e., “dynamic” IP address, where the IP address is assigned at the start of each connection and typically changes at points during the connection. On the other hand, a fixed address allows users to query the assigned ports for their devices at an unchanging location on the Internet.

For example, an typical internet protocol address might be http://184.172.128.161:8081. Adding the pre-established port number of “:8081” to the fixed Internet address of 184.172.128.161 tells the remote firewall that access is wanted to the LAN device associated with this port number. “http://” signals the browser to expect an HTML response. Once a fixed IP address is established and incoming ports are forwarded, a local network device can be successfully located and queried over the Internet at a fixed “IP address:port.” However, obtaining a fixed address from a cellular carrier can be difficult and often expensive.

Due to the high cost and effort to obtain a fixed IP address, dynamic domain name services (DDNS) can be an attractive alternative. DDNS circumvents the non-fixed IP address ambiguity problem where a LAN server is not at a fixed, unchanging network location. DDNS is a variation of the more familiar domain name server (“DNS”) function. DNS allows use of a human-recognizable word combination or character string, the uniform resource locator (“URL”) to be associated with an IP address for the desired server. So an exemplary pairing for DNS would be www.lanierford.com=123.456.789.123″. The user has the choice in their browser to type the words (and use a DNS server) or to use the IP address numbers directly to connect to the desired website. The user's DNS server maintains lookup tables that get updated whenever a change occurs in the IP address of any Internet server, but this happens slowly as the information is propagated to DNS servers around the world.

For cellular networks, DDNS is a trusted intermediary service that provides a URL that is automatically updated by the cellular modem whenever the carrier changes the modem's IP address. The user can now point their browser to the intermediary DDNS server and have a reliable “real-time” way to access the cellular modem's IP address whenever and wherever the user might be. Typically, DDNS service providers allow a user to specify a human recognizable character string like “lfsp01.ddnsprovidername.org”, which will be reliably redirected to the current IP address of the user's cellular device. The port numbers that would normally be at the end of the IP address can be specified at the end of the word string and will be appended to the IP address request sent to the remote device, example “lfsp01.ddnsprovidername.org:8081” is paired with the IP address “123.456.789.123:8081.”

However, conventional cellular modem data plans block incoming ports and non-fixed IP addresses, and these limitations are difficult to overcome. Persistent efforts and setup fees paid to the carrier may yield a workable, if unreliable and cumbersome, solution, but one that is nonetheless expensive. An appliance and method for enabling connecting of a network-to-network tunnel to a remote device with a main network over a wireless (e.g., cellular) unsecured network.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is an illustration of a system for enabling a virtual private network over an unsecured pubic network;

FIG. 2 is a functional block diagram of an exemplary tunneling appliance;

FIG. 3 is an block diagram of an exemplary encryption/decryption module; and

FIG. 4A is a top plan view of an exemplary encryption module; and

FIG. 4B is a section view of the exemplary encryption module as indicated.

### DETAILED DESCRIPTION

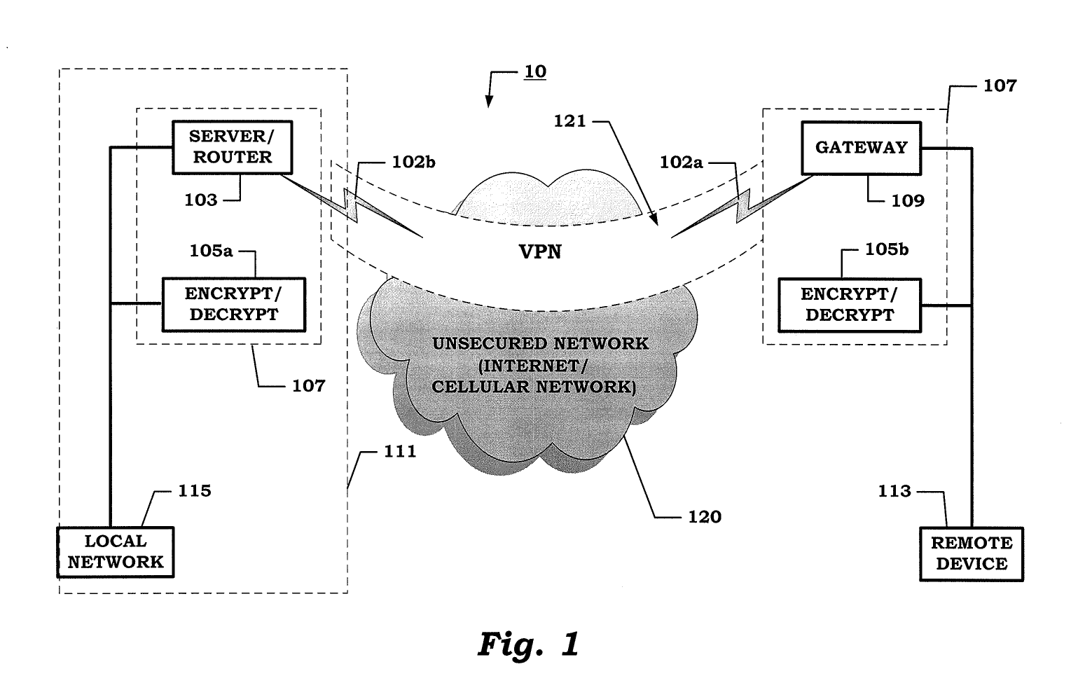

The various embodiments of the present invention and their advantages are best understood by referring to FIGS. 1 through 4 of the drawings. The elements of the drawings are not necessarily to scale, emphasis instead being placed upon clearly illustrating the principles of the invention. Throughout the drawings, like numerals are used for like and corresponding parts of the various drawings.

This invention may be provided in other specific forms and embodiments without departing from the essential characteristics as described herein. The embodiments described above are to be considered in all aspects as illustrative only and not restrictive in any manner. The appended claims rather than the following description indicate the scope of the invention.

FIG. 1 illustrates the main components of an exemplary system 10 comprising a VPN tunnel 121 over an unsecured public network 120. A secure local area network (LAN) 111 is comprised of a network of devices 115 coupled to a typical internet server/router 103 suitable for enabling data transfer 102b to and from the unsecured network 120. The server/router 103 is configured with a firewall for inhibiting unauthorized access to the local network 115. The LAN further comprises an encryption/decryption device 105a the characteristics and functions of which will be set forth in greater detail below.

A remote device 113 which could be any suitable computer-based device, e.g., a remote laptop or desktop computer, tablet, PDA, smart-phone, or the like now known or hereafter developed, is coupled to a tunneling appliance 107, such appliance itself comprising a wireless gateway 109, for example, a cellular modem, also configured with a firewall function and suitable for conveying data 102b from the remote device 113 to the unsecured network 120 and vice-versa, and an encryption/decryption device 105b consistent with the device 105 associated with the LAN 111. For the purposes of this description and as indicated in FIG. 1, the term “tunneling appliance” 107 will be understood to be the combination of a device for conveying data 102a,b directly to and from an unsecured network (e.g., server 103, and wireless gateway 109) and an encryption/decryption device 105.

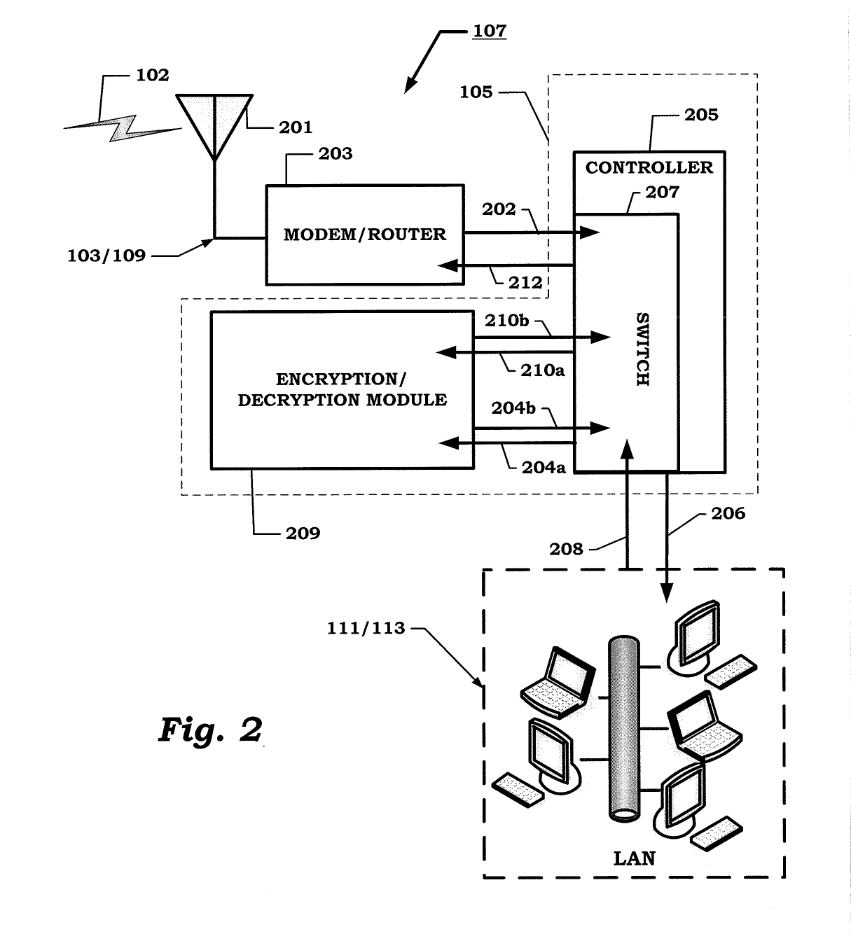

Referring now to FIG. 2, an exemplary tunneling appliance 107 comprises internet data device 103/109 that for illustration purposes only in the figure is shown to be a transceiver 203 which may be a cellular modem responsive to an antenna 201 that couples data signals 102 from a wireless network (FIG. 1, 120). The modem 203 is coupled to the encryption/decryption device 105 that is comprised of a data flow controller 205 that further includes a data switching device 207, and an encryption/decryption module 209. The data flow controller 205 is also coupled to the LAN or remote device 111/113.

As can also be appreciated from the figure, the exemplary data flow controller 205 is configured with a number of inputs and outputs to accommodate the various data signals as would be understood by those skilled in the relevant art. For example, an incoming wireless data signal 102 from the wireless unsecured wireless network 120 is coupled to the antenna 201 and conducted to the modem 203. The data signal 102 in this example is encrypted. The modem 203 demodulates the signal and outputs an encrypted data signal 202 that is received as input by the data flow controller 205. The data flow controller 205 is a computer-based processor (described below) configured to control the switch 207 and, in this circumstance, commands the switch 207 to convey the encrypted data signal 202 to be received as input 210a by the encryption/decryption module 209. The encryption/decryption module 209 is also a computer-based processor, and is configured to decrypt the encrypted signal 210a and output a decrypted signal 204b that is received as input by the controller 205, which in turn, commands switch 207 to conduct the signal to the remote device 113 (or LAN 111) as an unencrypted data signal 206, which may be, as an example, an Ethernet protocol signal.

Conversely, the remote device 113 (or LAN 111) may generate an outbound unencrypted data signal 208 that is received by the data flow controller 205 that causes the switch to conduct the signal 208 to be input 204a to be input to the encryption/decryption module 209, which outputs an outbound encrypted signal 210b. The outbound encrypted signal 210b is then conducted by the switch 207, in response to the data flow controller 205, to the modem 203 as an outbound encrypted, un-modulated data signal 212, the modem 203 then modulating the data signal for coupling to the network as a data signal 102.

To establish a VPN tunnel 121, the appliance 105b is configured to initiate a VPN tunnel 121 connection by sending an outbound message to the counterpart appliance 105a. The outbound message from the appliance 105a creates a temporary port opening through the firewalls. Once the counterpart appliance 105b receives the message to initiate from its remote partner 105a, the connection is negotiated, authenticated and encrypted through this port. The firewall's temporary port remains open to bi-directional network traffic unless the IP address of the cellular firewall changes or the connection is interrupted. Upon loss of connection, the remote appliance immediately begins sending connection initiation messages to reestablish the connection. Preferably, the tunneling appliance 105 forwards all broadcast and unicast Ethernet traffic to ensure that devices operate transparently over the tunnel 121. Tunnel-attached devices 105 will appear to LAN users to be directly on their own network and remote device users will appear to be directly on the LAN.

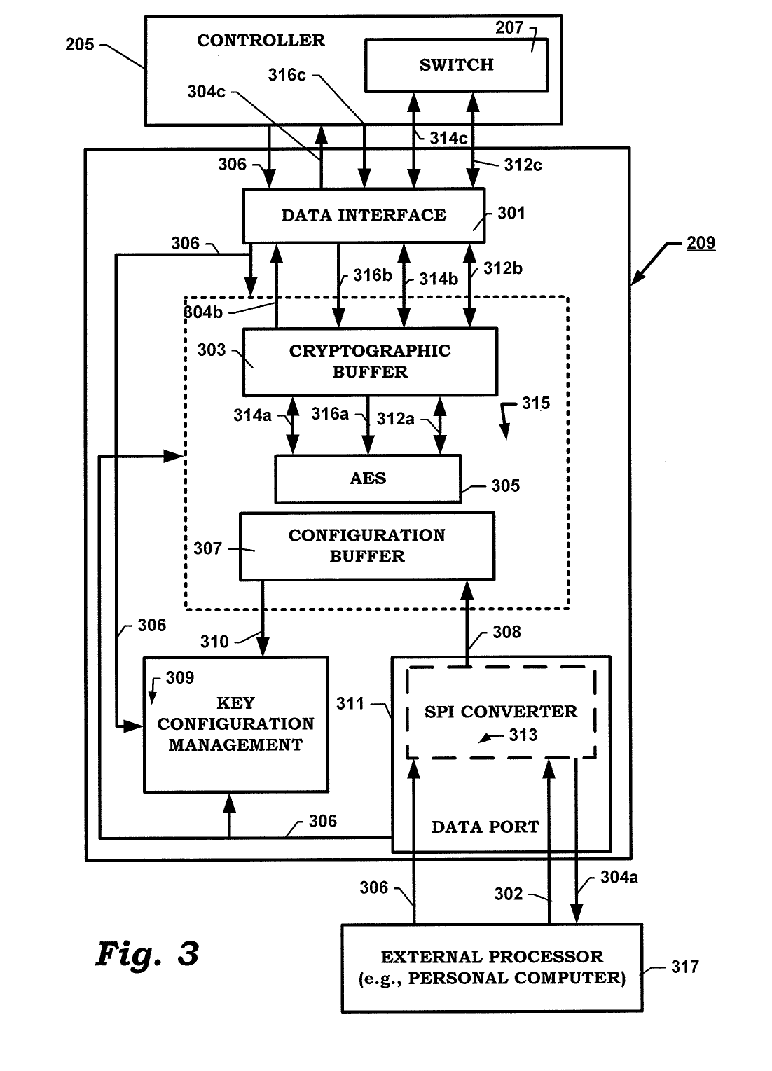

FIG. 3 provides a more detailed illustration of an exemplary encryption/decryption module 209 comprising a data interface 301, which is preferably a serial peripheral interface (“SPI”) suitable for coupling the module 209 to the data flow controller 205 and the switch 207. The module 209 may advantageously be achieved with a processor 315 comprising a buffer 303 for encrypted and decrypted data, a configuration buffer 307 for buffering encryption key data, and an encryption processor 305, which is preferably configured to encrypt or decrypt pursuant to the Advanced Encryption Standard (“AES”) or follow-on standards.

The module further comprises a key configuration management component 309 and a data port 311 for enabling external management of encryption key data from an external processor device 317. The data port may be, for example a universal serial bus (USB), and includes converter apparatuses 313, as required, for converting data from USB format to SPI data, as would be understood by those skilled in the art. For example, a universal asynchronous receiver/transmitter (“UART”) converter may be needed to translate data signals between serial and parallel formats depending upon the configuration of the data port 311. Module 209 may be implemented with one or more processors, and may be a “multi-chip module” (“MCM”).

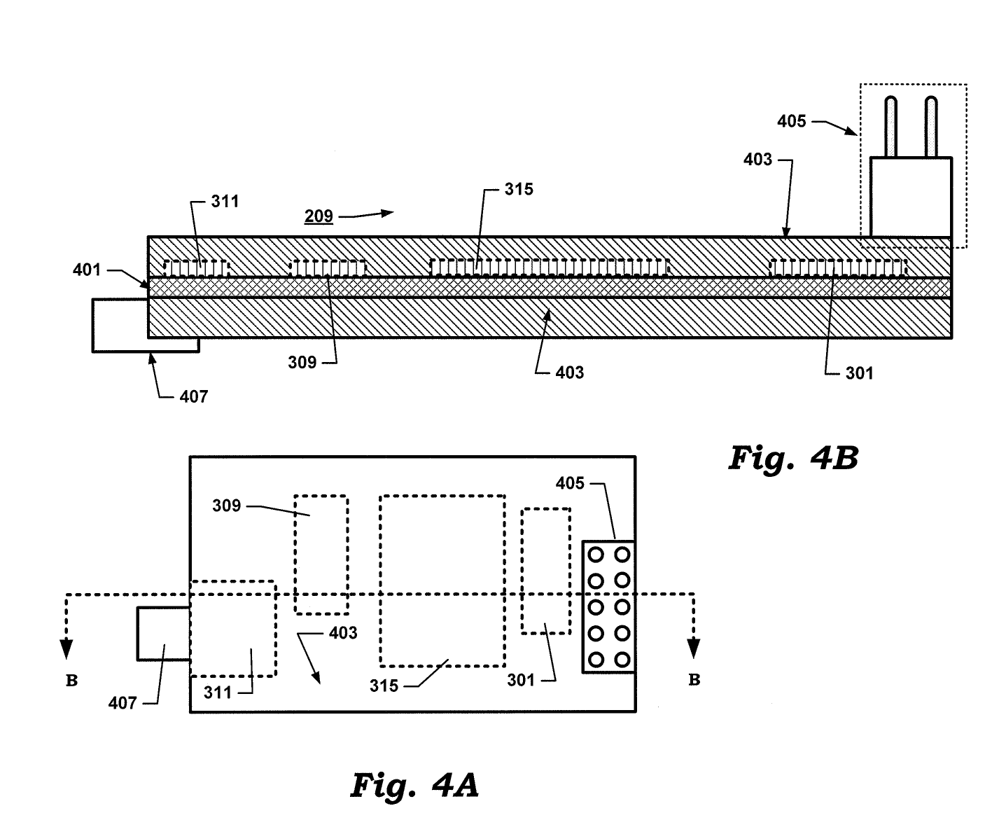

Module 209 is preferably adapted to meet U.S. Government Federal Information Processing Standards (“FIPS”) Pub. 140-2 Level II encryption standards, promulgated by the National Institute of Standards and Technology, which requires validated encryption devices to not only be resistant to unauthorized tampering, but also to be able to indicate when such tampering as occurred. To this end, and with reference to FIG. 4, an illustration of the module 209 comprising a circuit board 401 on which is disposed the data interface 301, the processor 315, the encryption key configuration management component 309 and data port 311. In addition, this illustration shows the SPI data pins 405, and a data port jack 407 that enables physical connection of the data port 311 to an external device (FIG. 3: 317). Encasing the board 401 and the components 301, 315, 309, 311, are two layers of potting 403. The potting 403 layers will evidence attempts to tamper with the processors because the potting will need to be removed in order to gain access.

Data flow through the module is illustrated in FIG. 3 as well where encrypted data signals 314c are coupled between the controller 205, and the switch 207, and the data interface 301, as described above with reference to FIG. 2. Additionally, the controller also transmits power and control signals (306b and 316c, respectively) to the module through the interface 301. The data interface relays the encrypted data signal 314b, control signal 316b and a power signal 306b to the processor 315, where the encryption and control signals 314b, 316b and are received by the cryptographic buffer 303 and which transfers them 314a, 316a to the encryption processor 305 for decryption. Decrypted signals 312a-c are conducted in reverse from the encryption processor 305 to the buffer 303, thence to the data interface 301, and to the controller 205, and in response to control signals 316a-c issued by the controller 205.

Meanwhile, encryption key management is enabled using an external processor 317 through the data port 311 with key data input signal 302 that may be translated into the appropriate data form by converter(s) 313, and conveyed 308 to the key configuration data buffer 307. Buffer 307 communicates key data 310 to the key configuration management component 309, which stores and coordinates encryption key data. Power signals 306 are also relayed through the data port 311 to the indicated components on the key configuration portion of the module 209.

As described above, many of the system's components may be achieved with the use of a computer-based processor. Accordingly, the detailed description that follows is presented largely in terms of processes and symbolic representations of operations performed by computer-based processors. A computer-based processor may be any microprocessor or processor (hereinafter referred to as processor) controlled device, such as, by way of example, personal computers, workstations, servers, clients, mini-computers, main-frame computers, laptop computers, a network of one or more computers, mobile computers, portable computers, handheld computers, palm top computers, personal digital assistants, interactive wireless devices, or any combination thereof. For example, a processor may also be implemented by a field programmable gated array (FPGA), an integrated circuit, an application specific integrated chip (ASIC), a central processing unit (CPU) with a memory or other logic device. The processor may possess input devices such as, by way of example, a keyboard, a keypad, a mouse, a microphone, or a touch screen, and output devices such as a processor screen, printer, or a speaker.

The processor may be a uniprocessor or multiprocessor machine. Additionally, the processor includes memory such as a memory storage device or an addressable storage medium. The memory storage device and addressable storage medium may be in forms such as, by way of example, a random access memory (RAM), a static random access memory (SRAM), a dynamic random access memory (DRAM), an electronically erasable programmable read-only memory (EEPROM), a programmable read-only memory (PROM), an erasable programmable read-only memory (EPROM), hard disks, floppy disks, laser disk players, digital video disks, compact disks, video tapes, audio tapes, magnetic recording tracks, electronic networks, and other devices or technologies to transmit or store electronic content such as programs and data.

The processor executes an appropriate operating system such as Linux, Unix, Microsoft® Windows® 95,Microsoft® Windows® 98, Microsoft® Windows® NT, Apple® MacOS®, IBM® OS/2®, and the like. The processor may advantageously be equipped with a network communication device such as a network interface card, a modem, or other network connection device suitable for connecting to one or more networks.

The processor, and the processor memory, may advantageously contain control logic or other substrate configuration representing data and instructions, which cause the processor to operate in a specific and predefined manner as, described herein. The control logic may advantageously be implemented as one or more modules. The modules may advantageously be configured to reside on the processor memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The control logic conventionally includes the manipulation of data bits by the processor and the maintenance of these bits within data structures resident in one or more of the memory storage devices. Such data structures impose a physical organization upon the collection of data bits stored within processor memory and represent specific electrical or magnetic elements. These symbolic representations are the means used by those skilled in the art to effectively convey teachings and discoveries to others skilled in the art.

The control logic is generally considered to be a sequence of processor-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for processor operations, and that these terms are merely conventional labels applied to physical quantities that exist within and during operation of the computer.

It should be understood that manipulations within the processor are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the processor or computers.

It should also be understood that the programs, modules, processes, methods, and the like, described herein are but an exemplary implementation and are not related, or limited, to any particular processor, apparatus, or processor language. Rather, various types of general purpose computing machines or devices may be used with programs constructed in accordance with the teachings described herein. Similarly, it may prove advantageous to construct a specialized apparatus to perform the method steps described herein by way of dedicated processor systems with hard-wired logic or programs stored in nonvolatile memory, such as, by way of example, read-only memory (ROM), for example, components such as application specific integrated circuits (ASICs) or field-programmable gated arrays (FPGAs). Implementation of the hardware state machine so as to perform the functions described herein will be apparent to persons skilled in the relevant art(s). In an embodiment where the invention is implemented using software, the software can be stored in a computer program product and loaded into the computer system using the removable storage drive, the memory chips or the communications interface. The control logic (software), when executed by a control processor, causes the control processor to perform certain functions of the invention as described herein.

As described above and shown in the associated drawings, the present invention comprises system for enabling a virtual private network over an unsecured network. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

I claim:

1. An appliance for enabling a virtual private network with security encryption between a local area network and a remote device over a wireless unsecured network comprising:
a transceiver configured to receive and demodulate an encrypted wireless network data signal from the wireless unsecured network and output an encrypted data signal, said transceiver also configured to inhibit unauthorized data signals;
a cryptographic module having an input and an output, and configured to receive said encrypted data signal and convert said encrypted data signal to a decrypted signal;
an encryption signal manager module comprising:
a computer-based processor having a memory comprising control logic; and
a switch, responsive to said processor, having a first input and a first output coupled to said receiver, a second input and a second output coupled to said cryptographic module, and a third input and a third output coupled to said remote device;
wherein the execution of said control logic causes said switch to:
conduct said encrypted data signal received at said first input to said second output and said cryptographic module; and
conduct a decrypted data signal output by said cryptographic module and received from said second input to said third output and said remote device.

2. The system of claim 1, wherein said cryptographic module is further configured to convert an unencrypted data signal into an encrypted outbound data signal and wherein said computer-based processor further comprises control logic, the execution of which controls said switch to:
conduct an unencrypted data signal from said LAN received at said third input to said second output and said cryptographic module; and
conduct an outbound encrypted data signal output by said cryptographic module received at said second input to said first output and said transceiver.

3. The system of claim 2, wherein said cryptographic module further comprises an external input/output port for enabling management of cryptographic data.

4. The system of claim 3, where said cryptographic module is encased potting suitable to indicate attempted tampering with said cryptographic module.

5. The system of claim 2, wherein said remote device is a LAN.

6. The system of claim 5, wherein said cryptographic module further comprises an external input/output port for enabling management of cryptographic data.

7. The system of claim 6, wherein said cryptographic module is encased in potting suitable to indicate attempted tampering with said cryptographic module.

8. A computer-based system for enabling encrypted transmission between a local network and at least one of a remote network and a remote computer-based device, said local area network coupled to a public network server for communicating with an unsecure public network and configured to inhibit unauthorized access to said local network, said system comprising:
a first computer-based tunneling appliance coupled to said local network and said server, said tunneling appliance comprising a first cryptographic module responsive to a first cryptographic data controller;
a second computer-based tunneling appliance comprising:
a remote modem configured to de-modulate data signals received from said unsecure public network and configured to inhibit the output of unauthorized data signals; and
a second cryptographic module responsive to a second cryptographic data controller; and
at least of one a remote network and a remote device coupled to said second tunneling appliance; and
wherein said first and second cryptographic modules are configured with pre-defined data to be exclusively, mutually responsive to one another; and
wherein said first and second cryptographic are configured with control logic that causes said first and second modules to:
decrypt encrypted data signals received from said server and said modem respectively; and
encrypted un-encrypted data signals received from said local network and said at least one of said remote network and remote device, respectively.

9. The system of claim 8, wherein said modem comprises an antenna suitable to couple wireless data signals received from said unsecured public network to said modem.

10. The system of claim 8, wherein said unsecured public network comprises a cellular wireless network.

11. The system of claim 8, wherein said first and second cryptographic modules are encased in a coating that reveals attempts to tamper with said modules.
